(19) United States
(12) Patent Application Publication
(10) Pub. No.: US 2005/0264528 A1
(43) Pub. Date: Dec. 1, 2005

(54) Low profile pointing device with tactile feedback

(76) Inventor: Stephen Wayne Burry, Berne, IN (US)

Correspondence Address: CTS CORPORATION, 905 W. BLVD. N, ELKHART, IN, 46514, US

(21) Appl. No.: 10/854,470

(22) Filed: May 26, 2004

(51) Int. Cl. G09G 5/00

(52) U.S. Cl. 345/157

(57) ABSTRACT

A low profile pointing device is described that includes a strain sensitive resistor assembly, a tactile feedback unit operably connected to the strain sensitive resistor assembly, and an actuator operably connected to the strain sensitive resistor assembly to produce an electrical signal in response to movement of the actuator and operably connected to the tactile feedback unit to receive tactile feedback. The tactile feedback unit includes a piezoelectric layer. The actuator is positioned over the tactile feedback unit and strain sensitive resistor assembly.

### FIELD

This invention generally relates to a pointing device for controlling the positioning, movement and operation of an electronic device, for example, a cursor on a display screen, and more specifically, to a pointing device with tactile feedback.

### BACKGROUND

Electronic devices use various pointing devices that act as cursor control mechanisms to provide a physical control over cursor placement on the display screen. A common form of cursor control device is a mouse. Because a mouse is used in a position physically remote from the computer, it is not the preferred cursor control device for portable electronic devices or laptop computers. When using such devices, users want the freedom to carry the device and to operate the device with as few external peripheral devices as possible. One cursor control mechanism incorporated into portable electronic devices is a pointing stick. These devices have been described in many patents and patent application publications including U.S. Pat. Nos. 5,640,178; 5,748,180; 5,966,117; 6,137,475; 6,195,082; 6,304,247; and 6,359,613; and U.S. Pat. Pub. Nos. 2002/0101838; and 2003/0128181, which are hereby incorporated by reference for any purpose.

Existing cursor control devices with tactile feedback are too large and use excessive power. Some cursor control devices rely on small electric motors that spin unbalanced shafts to create a feedback response to the user. Such devices are relatively large. Electronic devices continue to shrink in size as users demand smaller devices. Moreover, portable electronic devices have limited power supplies. Motors spinning unbalanced shafts consume a considerable amount of power to achieve the tactile feedback and significantly shorten battery life. Users prefer that their mobile electronic device be operable without external power for as long as possible. Moreover, it is desirable in some applications of cursor control devices to have a low profile so that the device does not extend significantly above the surface of the electronic device on which the cursor control is mounted. Accordingly, there is a need to provide tactile feedback in electronic devices that is small in size and does not consume a significant portion of the battery power.

### SUMMARY

The present invention is directed to a pointing device having tactile feedback. In an embodiment, the pointing device is a pointing stick. The tactile feedback unit includes a base layer of piezoelectric material beneath an actuator to provide tactile feedback to a user through the actuator. In an embodiment, the piezoelectric layer is a substantially horizontal layer beneath a low profile actuator. In an embodiment, the pointing device includes a strain sensitive resistor assembly operably connected to the actuator to produce an electrical signal in response to movement of the actuator. The tactile feedback unit is mechanically connected to the strain sensitive resistor assembly in an embodiment. The actuator is operably connected to the strain sensitive resistor assembly to produce an electrical signal in response to movement of the actuator and operably connected to the tactile feedback unit to receive tactile feedback. In an embodiment, the piezoelectric layer includes a stiffener or support layer. In an embodiment, an adhesive layer connects the stiffener or support layer to the piezoelectric layer. In an embodiment, the strain sensitive resistor assembly includes an insulator layer adjacent the piezoelectric layer. The insulator layer has an aperture in the center thereon to allow electrical connections to electrodes of the tactile feedback unit. The strain sensitive resistor assembly includes a plurality of strain sensitive resistors to provide different electrical signals depending on movement of the actuator. The strain sensitive resistor assembly includes a plurality of solder balls adapted to electrically communicate with the plurality of strain sensitive resistors and adapted to electrically and mechanically connect to an electrical board.

Embodiments of the present invention include an electrical circuit connected to the strain sensitive resistor assembly and the tactile feedback unit. The electrical circuit includes first contacts in electrical communication with the tactile feedback unit, the first contacts extending through the strain gauge resistor assembly. The circuit is adapted to control operation of the tactile feedback unit and the strain sensitive resistor assembly and eliminate interference or false readings during operation. This is accomplished by selectively operating one or the other of the strain sensitive resistor assembly and the tactile feedback unit. Other embodiments of the present invention further include methods for manufacturing the various embodiments described herein and devices in which the pointing device is used and/or mounted.

This Summary is an overview of some of the teachings of the present application and is not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 shows an electronic device incorporating an embodiment of the present invention

FIG. 2 shows a cross-sectional view of a pointing device according to an embodiment of the present invention.

FIG. 3 shows a plan view of the top electrode taken generally along line 3-3 of FIG. 2.

FIG. 4 shows a view of the lower electrode taken generally along line 4-4 of FIG. 2.

FIG. 5 shows a view of an insulative layer taken generally along line 5-5 of FIG. 2.

FIG. 6 shows a view of a strain gage layer taken generally along line 6-6 of FIG. 2.

FIG. 7 shows an electrical schematic according to an embodiment of the present invention.

It should be noted that the drawings are not to scale.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

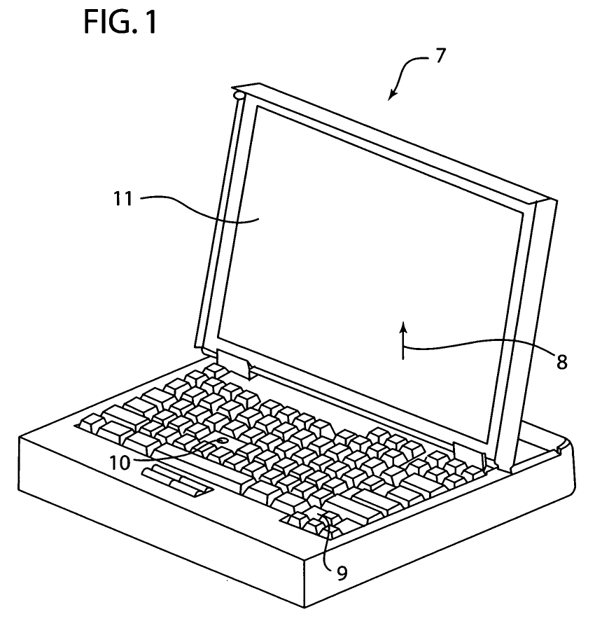

Electrical devices, such as computers, laptop computers, personal data assistants, palmtops, game systems, typically are controlled by users through the use of various input control devices including a cursor control device and a keyboard. Electronic device 7 typically has a program running thereon that provides for movement of a cursor 8 on display device 11 in response to the user operating the cursor control device 10, such as a pointing stick. Examples of such programs include Microsoft Windows ME, PalmOS, Unix, Linux, Apple OS, and other operating systems, e.g., proprietary gaming systems. Display device 11 can be any of a number of different devices, such as an LCD attached to an electronic computing device; other similar devices such as a computer monitor employing a cathode ray tube (CRT) may also be used. Electronic device 7 as shown in FIG. 1 is a laptop computer, although the invention is not limited to any particular configuration. For example, electronic device 7 is a desktop, tower, or handheld system in other embodiments of the invention. As shown in FIG. 1, cursor control device 10 is mounted between the “g” “h” and “b” keys on a standard “QWERTY” laptop keyboard 9. The term “QWERTY” is a common term used to describe the layout of the keyboard based upon the first six letters across the top row of keys. It will be recognized that the cursor control device 10 of the present invention is connected to the electronic device in other ways according to other embodiments of the present invention, for example, in convenient locations for access by a user's finger. It will also be recognized that a cursor generally provides a visual cue on a display that indicates position.

Cursor control device 10 allows a computer user to move the cursor 8 on display device 11. Cursor control device 10 therefore translates movement by the user into an electronic signal provided to the electronic device via a communications link which is internal to the electronic device 7. Not shown is that electric device 7 typically includes a processing unit, for example, a central-processing unit (CPU), a random-access memory (RAM), and a read-only memory (ROM). The CPU, RAM, and ROM may be of any type; the invention is not particularly limited. In one embodiment, the CPU is an Intel processor, there are sixty-four megabytes of RAM, and the ROM contains such functionality as a basic input/output system (BIOS). Also not shown is that electronic device 7 usually comprises a fixed storage device such as a hard disk drive with software resident thereon, and a removable storage device such as a floppy disk drive or optical media drive. The electronic device may further be connected to a network, local or global, to exchange electrical signals for any of its functions.

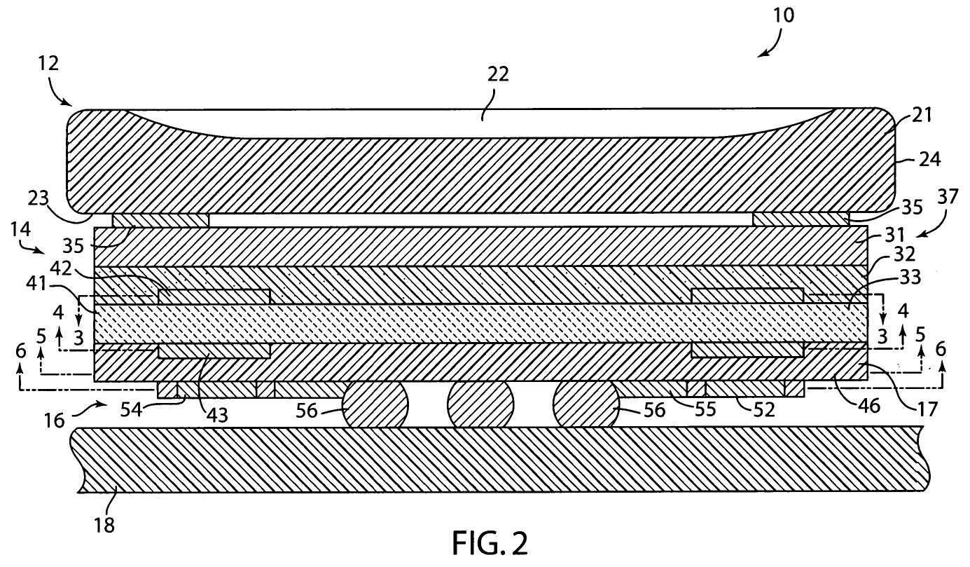

Referring to FIG. 2, cursor control device 10 according to the present invention is shown. Cursor control device 10 includes an actuator 12, a tactile feedback unit 14, a signal producing assembly 16, and a base 18. The actuator 12 is engaged by a user's finger to move the cursor control device 10 and produce electrical signals based on the actuator movement. The tactile feedback unit 14 provides selective physical feedback to the user through the actuator 12. The signal producing assembly 16 provides electrical signals based on movement of the actuator 12 by the user. These electrical signals provide an input in the electronic device 7. Base 18 is a circuit board, for example, a printed circuit board (not shown) that provides mechanical support and ability to mount the cursor control device to the electronic device 7. Base 18 further includes electrically conductive traces thereon to provide electric communication between electronic device 7 and the tactile feedback unit 14 and the signal producing assembly 16.

Actuator 12 has a rigid body 21 that is wider than it is tall to provide a low profile relative to the electronic device 7. In an embodiment, the body 21 has a height that is less than the height of the feedback unit 14 and signal producing assembly 16. The low profile of body 12 ensures that the cursor control device 10 does not contact another part of electronic device 7, such as the screen, or snag on the environment in which device 7 is used or stored. Body 21 includes a top surface 22, which is centrally recessed to receive a user's finger tip. The bottom surface 23 of body 21 is essentially planar and is adapted to be fixed to the tactile feedback unit 14. A peripheral edge 24 extends between the top surface 22 and bottom surface 23.

Tactile feedback unit 14 has a support layer 31, an adhesive layer 32, and a piezoelectric device 33. In an embodiment, the tactile feedback unit 14 is inwardly, radially recessed from the actuator peripheral edge 24. Connection points 35 fix support layer 31 to bottom surface 23 of body 21. Connection points 35 are adhesives such as polymers, epoxy or glue in an embodiment. Connection points 35 are positioned at the periphery of the support layer 31 and the actuator 12. In an embodiment, there are four connection points 35, which are positioned about ninety degrees from one another so that movement of the actuator in any of the four directions, e.g., up, down, right, and left, are accurately transferred to the remainder of the cursor control device. Support layer 31 provides a base layer that has adequate stiffness for the remaining elements of the tactile feedback unit and transmits the forces applied to the actuator 12 to the remainder of the cursor control device. In an embodiment, the support layer 31 includes a metal. In an embodiment, the support layer includes a plastic. In an embodiment, the actuator 12 has a slightly larger area than the support layer 31. Adhesive layer 32 is fixed to the bottom surface of support layer 31 and to an upper surface of piezoelectric assembly 37. Piezoelectric assembly 37 includes a piezoelectric layer 41, upper electrodes 42 on an upper surface of piezoelectric layer 41, and lower electrodes 43 on a lower surface of piezoelectric layer 41. The upper and lower electrodes 42 and 43 are connected to a circuit that controls the voltages on the electrodes so as to create an electric field between the electrodes 42 and 43 to cause the piezoelectric layer 41 to change shape, i.e., deflect to produce a tactile feedback. Such an action by the piezoelectric material is referred to as electrostriction. An insulating layer 46 is provided on the lower electrode 43 and on the lower surface of the piezoelectric layer 41 to electrically isolate the lower electrode from other electrical components and stray environmental charges.

Signal producing assembly 16 includes strain sensitive resistors 51, 52, 53, 54 that form a bridge circuit formed on a side of insulating layer 46 remote from piezoelectric layer 41. In an embodiment, the signal producing assembly 16 is inwardly, radially recessed from the actuator peripheral edge 24. The strain sensitive resistors 51, 52, 53, 54 are preferably thick film devices screen printed onto the bottom surface of tactile feedback unit 14. Resistors 51, 52, 53, 54 are selected so that when the signal producing assembly 16 is placed under stress, the electrical resistance of the resistors 51, 52, 53, 54 will vary in direct relation to the amount and relative direction of stress. Electrically conductive traces 55 are formed on the insulating layer 46 to provide an electrical interconnection of resistors 51, 52, 53, 54 to contact pads 56.

The contact pads 56 physically and electrically connect to electrically conductive traces (not shown) on the base 18. The contact pads 56 are located proximal or close to the cursor control device 10. This is done to focus the stress between the center of signal producing assembly 16 and the contact point with the actuator 12 around the peripheral edge 17 of the signal producing assembly 16. The resistors 51, 52, 53, 54 are located in this stress region radially intermediate the contact points 35 and the solder pads 56.

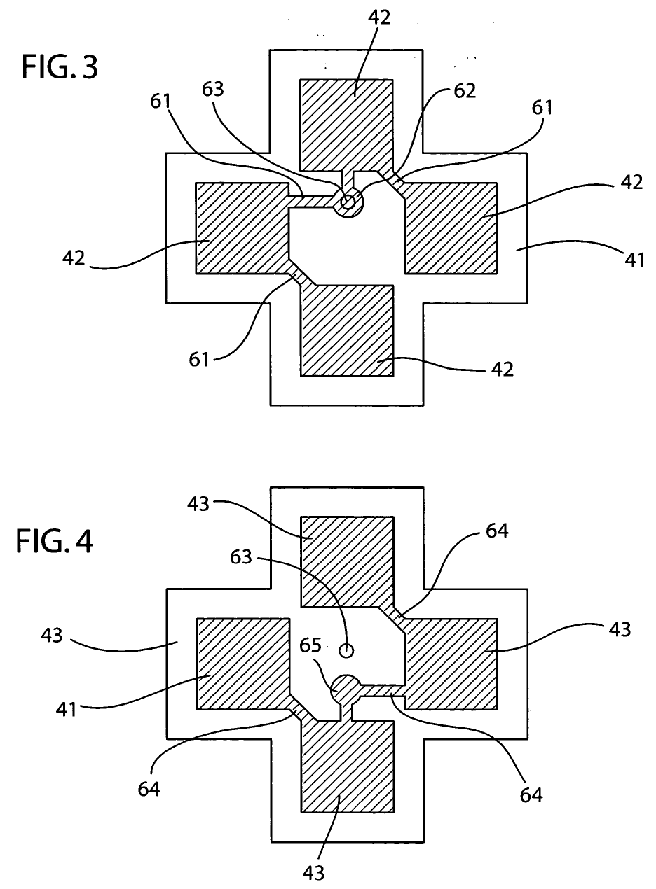

FIG. 3 is a view taken essentially along line 3-3 of FIG. 2. The piezoelectric layer 41 provides a cross-shaped substrate, which on the upper surface thereof (adjacent the actuator 12) are formed a plurality of upper electrodes 42. The upper electrodes 42 cover a significant portion of the upper surface of outwardly extending arms of the piezoelectric layer 41 and extend into a central region of the piezoelectric layer 41. In an embodiment, the upper electrodes 41 each have a rectangular shape. Conductive traces 61 extend between the upper electrodes 42. A via 62 is formed through a central region of piezoelectric layer 41. A conductive material is deposited in the via 62 to form an interlayer conductor or plug 63. In an embodiment, the material for the plug is deposited in the via and the material is fired to form the conductive plug 63. It will be noted that the adhesive layer 32 is not shown in FIG. 3 for clarity of showing the piezoelectric layer 41.

FIG. 4 is a view taken generally along line 4-4 of FIG. 2. A plurality of lower electrodes 43 are formed on the lower side of the piezoelectric layer 41, i.e., remote from the actuator 12. Lower electrodes 43 are vertically aligned with the upper electrodes 42. The lower electrodes 43 cover a significant portion of the lower surface of outwardly extending arms of the piezoelectric layer 41 and extend into a central region of the piezoelectric layer 41. In an embodiment, the lower electrodes 43 each have a rectangular shape. Conductive traces 64 extend between the lower electrodes 43. One of traces 64 includes a contact pad 65 that is located centrally on the piezoelectric layer 41. It will be noted that the insulative layer 46 is not shown in FIG. 4 for clarity of showing the lower electrodes 43.

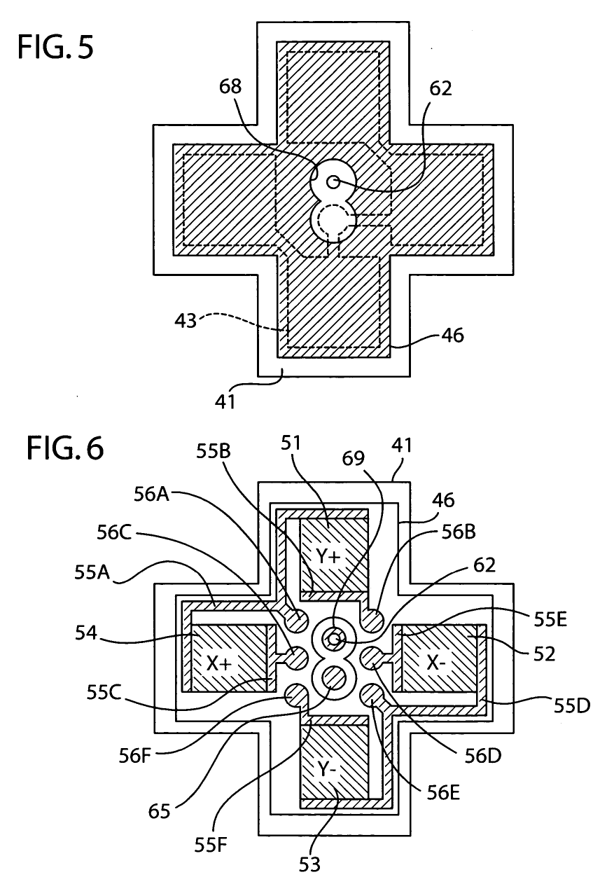

FIG. 5 is a view taken generally along line 5-5 of FIG. 2. An insulative layer 46 is formed covering the lower electrodes 43. In an embodiment, the insulative layer 46 is recessed inwardly from the periphery of the piezoelectric layer 41 and extends outwardly of the lower electrodes 43 to enclose the lower electrodes against the piezoelectric layer. An aperture 68 is formed centrally in the insulative layer 46. Aperture 68 has a two part hourglass or figure eight shape with the upper electrode plug 62 extending through one aperture part and the contact pad 65 extending into the other aperture part. The aperture allows the upper and lower electrodes 42 and 43 to be connected to an external drive circuit, which controls operation of the tactile feedback unit 14, by providing an electric field across the piezoelectric layer 41. This causes the piezoelectric layer 41 to change shape and creates a mechanical deformation of layer 41 so that the user will feel the deformation through the actuator 12.

FIG. 6 is a view taken generally along line 6-6 of FIG. 2. A contact pad 69 in electrical and mechanical contact to plug 62 is formed in a part of aperture 68. A plurality of resistors 51, 52, 53, and 54 of the signal producing assembly 16 are formed on the bottom surface of the insulative layer 46 remote from the lower electrodes 43. The resistors 51, 52, 53, and 54 are strain sensitive resistors that change resistance when they experience strain. The strain is placed on the resistors 51, 52, 53, and 54 through the layers above the resistors, e.g., the tactile feedback unit 14, by the user moving the actuator 12. Each resistor 51, 52, 53, and 54 is positioned along one of the four arms of the cross shaped structure above the resistors. In the embodiment shown in FIG. 6, resistors 51 and 53 sense the movement of actuator 12 in the Y-direction. Movement of the actuator 12 in the Y direction will change the resistance of at least one of resistors 51 and 53. Resistors 52 and 54 sense the movement of actuator 12 in the X-direction. Movement of the actuator 12 in the X-direction will change the resistance of at least one of resistors 52 and 54. A conductive trace 55A interconnects outwardly positioned nodes of resistors 51 and 54 to a contact pad 56A. A conductive trace 55B connects an inward node of resistor 51 to a contact pad 56B. A conductive trace 55C connects an inward node of resistor 54 to a contact pad 56C. A conductive trace 55D interconnects outwardly positioned nodes of resistors 52 and 53 to a contact pad 56E. A conductive trace 55E connects an inward node of resistor 52 to a contact pad 56D. A conductive trace 55F connects an inward node of resistor 53 to a contact pad 56F. Contact pads 56A-56F are located centrally on the cross-shaped insulative layer 46. In the embodiment shown in FIG. 6, three contact pads 56A, 56C, and 56F are positioned along one side of aperture 68 and are generally parallel to contact pads 65 and 69 for the upper and lower electrodes of the tactile feedback unit. The other three contact pads 56B, 56D, and 56E are positioned along the other side of aperture 68 and are generally parallel to contact pads 65 and 69. The contact pads 56A-56F are positioned centrally to concentrate the strain forces on the resistors 51-54. Each of the contact pads 56A-56F form a mechanical and electrical interconnect to the base 18.

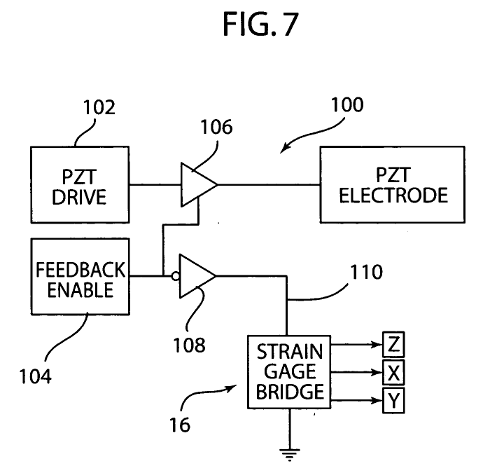

FIG. 7 shows a schematic view of a drive circuit 100 for an embodiment of the present invention. A piezoelectric drive signal generator 102 supplies a piezoelectric drive signal to provide an electrical field across the piezoelectric layer 41 that will cause the layer to mechanically deform. A feedback enable generator 104 provides an enable signal to a switch 106 that controls when the piezoelectric drive signal is supplied to the upper electrodes and the lower electrodes. In the illustrated embodiment, the piezoelectric drive signal is supplied to the upper electrodes 42 and the lower electrodes 43 are grounded. The feedback enable signal is also supplied to inverter 108. The inverter 108 provides a signal on line 110 to control operation of the signal producing assembly 16. Specifically, inverter 108 grounds the signal producing assembly 16 at line 110 when the feedback enable signal is high. Inverter 108 supplies a system voltage, i.e., Vcc, typically 5 or 3.3 volts, to the signal producing assembly 16 through line 110 when the feedback enable signal is low. Accordingly, signal producing assembly 16 produces Z, X, and Y output signals when it is receiving the system voltage and does not produce an output when its input from inverter 108 is low (feedback enable is high).

A brief description of the fabrication process follows. The cursor control device 10 is fabricated using thick film technology in an embodiment of the present invention. First, a piezoelectric substrate 41 is provided. Examples of piezoelectric materials include quartz (SiO₂), or barium titanate (BaTiO₃). A preferred piezoelectric material for the present application is lead zirconium titanate (PZT). PZT is fabricated in to the cross shape as discussed above in an embodiment. The piezoelectric material must be poled to operate correctly. Poling is the process of aligning the dipoles in the material. This is done by applying a strong DC electric field across the material. In an embodiment, the voltage applied to a substrate to align the dipoles is about 90 volts per 0.001 inch of thickness. Accordingly, a 0.010 inch substrate would be poled by a voltage of about 900 volts. Via 62 is formed through the piezoelectric substrate. A conductive material fills the via. The material is fired, if needed, to form the conductive plug 63 through the piezoelectric substrate. Material for the upper electrodes 42 and conductive traces 61 are patterned on the top surface of the piezoelectric substrate 41. In an embodiment, patterning includes screen printing the material. In an embodiment where the piezoelectric material is already poled, then the material for the electrodes 42 and traces 61 must be cured or fired at a low temperature, typically less than 200 degrees C. In an embodiment, the low temperature for fixing the electrode and trace material is about 175 degrees C. In an embodiment where the piezoelectric material is not yet poled, then the material for electrodes 42 and traces 61 can be cured or fired at a high temperature, e.g., in the range of 200 degrees C. to about 850 degrees C. The electrodes 42 and traces 61 are fired to fix them to the piezoelectric substrate. The substrate is flipped so that the “lower side” is now facing upward. Material for the lower electrodes 43 and conductive traces 64 is patterned on the lower surface of the piezoelectric substrate 41. In an embodiment, the material for the contact pad 69 for the upper electrodes 42 is patterned on the same side as lower electrodes 43 and is in contact with plug 63. The lower electrodes 43, traces 64 and contact pad 65 are formed similar to the upper electrodes depending on the nature of poled status of the piezoelectric material.

An insulative layer 46 is formed on the lower electrodes 43, traces 64, and at least a portion of the piezoelectric substrate 41. In an embodiment the insulative layer 46 completely covers one side of the piezoelectric substrate 41. An aperture 68 is formed in the center of the insulative layer 46 so that the upper electrode contact pad 69 and the lower electrode contact pad 65 is uncovered by insulative layer 46. In an embodiment, the aperture is formed by a subtractive process, i.e., the insulative layer 46 is initially formed to cover the pads 65, 69 and the insulative material on pads 65, 69 is removed to uncover the pads. In another embodiment, the insulative layer 46 is initially patterned with the aperture therein. In the embodiment where the piezoelectric layer is poled in a subsequent fabrication process, then the insulative layer 46 must be able to insulate to at least the voltages required for poling. The insulative layer 46 forms a further fabrication surface on which a bridge circuit, which includes strain sensitive resistors 51, 52, 53, and 54, traces 55A-55F and contact pads 56A-56F, is fabricated. The resistors 51-54 are screen printed on the insulative layer 46. In an embodiment, the resistors are polymer resistors that are cured. In an embodiment, the resistors are metallic conductive elements and are fired to fix same to the insulative layer. The resistors 51-54 are trimmed using a laser so that the resistors have a resistance that is within the tolerances for the present application. The traces 55A-55F are formed by screen printing the same on the insulative layer.

If the piezoelectric layer is not yet poled, then it is poled. The stiffener layer 31 is fixed to the upper electrode side of the piezoelectric layer 41 by the adhesive layer 32. The adhesive layer 32 is a polymer in an embodiment. The adhesive layer is not electrically conductive. The actuator 12 is fixed to the stiffener layer 31.

While the above describes embodiments of the invention as it relates to cursor control, it will be recognized that other embodiments are adaptable for use with other device. For example, embodiments of the present pointing device can be used to move through menu trees or provide remote movement control signals for mechanical devices such as vehicles, construction equipment, robotics, etc.

1. A device, comprising:
a strain sensitive resistor assembly;
a tactile feedback unit operably connected to the strain sensitive resistor assembly, the tactile feedback unit includes a substantially horizontal, piezoelectric layer; and
an actuator operably connected to the strain sensitive resistor assembly to produce an electrical signal in response to movement of the actuator and operably connected to the tactile feedback unit to receive tactile feedback.

2. The device of claim 1, wherein the tactile feedback unit includes a substrate to support the piezoelectric layer.

3. The device of claim 2, wherein the tactile feedback unit includes an adhesive layer connecting the substrate to the piezoelectric layer.

4. The device of claim 2, wherein the actuator is in contact with the support, and the piezoelectric layer in beneath the support.

5. The device of claim 4, wherein the strain sensitive resistor assembly is beneath the piezoelectric layer.

6. The device of claim 5, wherein the strain sensitive resistor assembly includes an insulator layer adjacent the piezoelectric layer.

7. The device of claim 6, wherein the strain sensitive resistor assembly includes a plurality of strain sensitive resistors to provide different electrical signals depending on movement of the actuator.

8. The device of claim 7, wherein the strain sensitive resistor assembly includes a plurality of solder balls adapted to electrically communicate with the plurality of strain sensitive resistors and adapted to electrically and mechanically connect to an electrical board.

9. The device of claim 1, wherein the piezoelectric layer extends essentially the width of the actuator.

10. The device of claim 9, wherein the piezoelectric layer extends essentially the length of the actuator.

11. The device of claim 10, wherein the actuator includes a finger-engaging body and at least four mechanical contacts on the body and in mechanical contact with the tactile feedback unit, and wherein at least one contact is positioned at each end of the length and the width of the actuator.

12. The device of claim 11, wherein the piezoelectric layer has a cross shape.

13. The device of claim 1, wherein the tactile feedback unit includes first and second contacts in electrical communication with the piezoelectric layer and adapted to electrically and mechanically connect to an electrical board.

14. The device of claim 13, wherein the first and second contacts are positioned centrally relative to the piezoelectric layer.

15. The device of claim 14, wherein the first and second contacts are positioned centrally relative to the strain sensitive resistor assembly and the actuator.

16. The device of claim 15, wherein the strain sensitive resistor assembly includes resistors and an insulative layer intermediate the resistors and the piezoelectric layer, and wherein the insulative layer includes a central aperture through which the first and second contacts extend.

17. The device of claim 1, wherein the actuator is a pointing stick.

18. A device, comprising:
a strain sensitive resistor assembly;
a tactile feedback unit operably connected to the strain sensitive resistor assembly, the tactile feedback unit includes a substantially horizontal, piezoelectric layer;
an actuator operably connected to the strain sensitive resistor assembly and the tactile feedback unit to receive tactile feedback; and
an electrical circuit connected to the strain sensitive resistor assembly and the tactile feedback unit.

19. The device of 18, wherein the electrical circuit includes a feedback enable circuit to enable the tactile feedback unit and disable the strain sensitive resistor assembly.

20. The device of claim 19, wherein the strain sensitive resistor forms a bridge circuit and the electrical circuit produces an output based on a signal change in the bridge circuit caused by movement of the actuator.

21. The device of claim 19, wherein the bridge circuit is grounded when the piezoelectric layer is energized.

22. The device of claim 21, wherein the bridge circuit is connected to a voltage source when the piezoelectric layer is not energized.

23. The device of claim 18, wherein the electrical circuit includes first contacts in electrical communication with the tactile feedback unit, the first contacts extending through the strain sensitive resistor assembly.

24. The device of claim 23, wherein the strain sensitive resistor assembly includes a plurality of resistors adapted to change resistance based on mechanical forces thereon, the resistors being positioned outwardly of the contacts.

25. The device of claim 24, wherein the plurality of resistors include at least four resistors.

26. The device of claim 24, wherein the tactile feedback assembly includes an insulative layer on the piezoelectric layer, and the resistors are on the insulative layer.

27. The device of claim 26, wherein the insulative layer is recessed inwardly relative to the piezoelectric layer.

28. The device of claim 18, wherein the actuator has a width and length significantly greater than its height.

29. A cursor control device for an electronic device comprising:
a planar piezoelectric substrate having a top surface and a bottom surface;
a top electrode mounted to the top surface and a bottom electrode mounted to the bottom surface, the substrate adapted to vibrate in response to a first electrical signal applied to the electrodes;
an insulating layer mounted over the bottom electrodes and the bottom surface; and
a plurality of strain sensitive resistors mounted to the insulating layer, the strain sensitive resistors adapted to generate a second electrical signal that is indicative of a force and a direction applied to the substrate by a user.

30. The cursor control device according to claim 29, wherein an actuator is attached to the top surface.

31. The cursor control device according to claim 30, wherein the actuator further comprises:
a body;
a stiffener attached to one side of the body; and
an adhesive located between the top surface of the piezoelectric substrate and the stiffener.

32. The cursor control device according to claim 29, wherein the resistors are connected to a conductive trace.

33. The cursor control device according to claim 32, wherein a solder ball is connected to the conductive trace.

34. The cursor control device according to claim 33, wherein the solder ball is located toward the center of the piezoelectric substrate.

35. The cursor control device according to claim 29, wherein the strain sensitive resistors are located toward an outer peripheral edge of the piezoelectric substrate.

36. The cursor control device of claim 29, wherein the plurality of strain sensitive resistors are operably connected to a computer.

37. The cursor control device of claim 29, wherein the second electrical signal is sensed when the first electrical signal is off.

38. A cursor control device for an electronic device, comprising:
a planar piezoelectric substrate having a top surface and a bottom surface;
a top electrode mounted to the top surface and a bottom electrode mounted to the bottom surface, the substrate adapted to vibrate in response to a first electrical signal applied to the electrodes;
an actuator operably connected to the piezoelectric substrate;
a plurality of strain sensitive resistors operably connected to the actuator;
the strain sensitive resistors adapted to generate a second electrical signal that represents a direction applied to the actuator; and
a circuit connected to the piezoelectric substrate and the strain sensitive resistors.

39. The cursor control device of claim 38, wherein the circuit is adapted to apply the first electrical signal when not reading the second electrical signal.

40. The cursor control device of claim 38, wherein the circuit is adapted to receive the second electrical signal exclusive of applying the first electrical signal.

41. The cursor control device of claim 40, wherein the circuit is adapted to produce control signals for a graphic indicator in an electronic device.

42. The cursor control device of claim 41, wherein the graphic indicator includes a cursor.

43. The cursor control device of claim 38, wherein the substrate includes an insulating layer over the bottom electrodes, and wherein the plurality of strain sensitive resistors are on the insulating layer.

44. A cursor control for an electronic device comprising:
means for providing a tactile response to a user based on a first electrical signal;
an insulating layer mounted to the means for providing a tactile response; and
a strain sensitive assembly operably connected to the insulating layer, the strain sensitive assembly being adapted to generate a second electrical signal that is indicative of a force and a direction applied by a user.

45. The device of claim 44, wherein the means for providing tactile response includes a planar piezoelectric layer that has first and second electrodes.

46. The device of claim 44, wherein the means for providing tactile response includes a circuit adapted to not read the second electrical signal with the first electrical signal being active to provide the tactile response.

47. The device of claim 44, wherein the means for providing tactile response includes a circuit adapted to read the second electrical signal with the first electrical signal being in a non-active state.
